(19) United States
(12) Patent Application Publication
(10) Pub. No.: US 2025/0336383 A1
(43) Pub. Date: Oct. 30, 2025

(54) MAGNETIC PICKUP AND TONE MODIFICATION CIRCUIT FOR STRINGED MUSICAL INSTRUMENT

(71) Applicant: Zone Musical LLC, Wylie, TX (US)

(72) Inventor: Charles Brian Richardson, Wylie, TX (US)

(21) Appl. No.: 19/088,969

(22) Filed: Mar. 24, 2025

Related U.S. Application Data
(60) Provisional application No. 63/639,089, filed on Apr. 26, 2024.
(60) Provisional application No. 63/654,651, filed on May 31, 2024.

(51) Int. Cl. G10H 3/18

(52) U.S. Cl. CPC G10H 3/181; G10H 2220/515

(57) ABSTRACT

A magnetic pickup assembly for a stringed instrument comprises a base plate and four ferrous rails or polepiece arrays, three magnets arranged between the four rails/poles, and four pickup coils. Two sets of two rails/poles are disposed on the base plate and include an inner set and an outer set. Each rail/polepiece array has a coincident coil. The three permanent magnets are specifically provisioned and attached to the base plate. The two humbucking outputs of the pickup are connected externally in a series configuration. A passive RC network is connected to the two coil pairs in series. By provision of component values of the RC network, output frequency response to string vibrations may be controlled over a wide range. The complete design provides a variable frequency-selective string aperture feature which assists in obtaining pleasing tonality over the range of adjustment. Alternate embodiments may use active electronic circuitry.

### CROSS-REFERENCE TO RELATED APPLICATION

This application claims the benefit of U.S. Provisional Appl. No. 63/639,089 filed Apr. 26, 2024 and U.S. Provisional Appl. No. 63/654,651 filed May 31, 2024, which are both incorporated herein by reference in their entireties.

### FIELD OF THE DISCLOSURE

The subject matter of present disclosure is directed to providing design and functional improvement of variable reluctance magnetic pickups and associated onboard tone modification electrical circuitry, with the specific but non-exclusive field of application of stringed musical instruments, such as electric guitars and electric bass guitars.

### BACKGROUND AND DESCRIPTION OF THE RELATED ART

The electric guitar, as historically originated and developed in the last century, has been and is now a primary tool used by musicians to create, reinterpret, and perform traditional music, as well as pioneer completely new genres of music, over the decades through the present. The sonic role of the electric guitar in each of these old and new genres depends on not only nuanced artist performance, but also upon almost genre-specific combinations of the perceived tonality of the instrument, in conjunction with operating through amplifiers and other equipment designed (and evolved) to work with the instrument's electrical output signal.

As the primary interface between the musician, the strings, and the amplification and effects signal chain, the pickup(s) with their own physical and electrical characteristics, in addition to the onboard volume and tone control circuits, play the dominant roles in the electric guitar's tonality. Differences in the range of tonality and subjective tone qualities available on specific instruments, primarily due to the basic design and characteristic electrical response of the magnetic pickups, positioning under the string set, and onboard circuits, have led to specialization in the market, where certain types and models of electric guitars have historically and through the present, been preferred for certain types and styles of music. An example of this is found in electrified country music of the 50's through 80's, where historically a “twangy and bright” (characteristic frequency response with prominent high frequency content around 3-5 KHz) and “clean” (relatively non-distorted but colored by the amplifier) electric guitar tone of a specific model guitar (Fender Telecaster) with single coil pickups, was and is generally preferred in conjunction with specific models of tube amplifiers, which of course have their own characteristics which influence perceived tonality.

In contrast, with the inception and evolution of rock, metal, and electric blues music from the same era to present, an instrument electrical output with greater hum/noise rejection, higher output both overall and in the lower midrange frequencies, lessened high frequency output, and therefore less audibly prominent transient response to the player striking the strings, characteristic of humbucking pickups, was discovered to be better for obtaining specific tonalities obtained in conjunction with more gain and distortion in the downstream electronics, characteristic of those genres. As a result, different models of instruments with humbucking pickups (e.g., Gibson Les Paul model) were and still are generally preferred for those genres.

Due to these limitations in the tonality ranges of the pickups and associated electrical circuits of different types and models of electric guitars of the past and today, many current professional and non-professional players often feel the necessity to own several different guitars, just to be able to have the tonalities available, by switching instruments, to cover playing in different genres or specific songs for live performance or recording.

Over the decades, multiple factors in the market have driven significant product proliferation and differentiation, both in factory pickups in Original Equipment Manufacturer (OEM) instruments and in aftermarket replacement pickups and electronics, but in general, the vast majority of currently available electric guitars are equipped with pickups of one type or another (referred to as either single-coil or humbucking pickups a.k.a. humbuckers,) there is an expected range of tonality for each of those types, and the traditional control designs (simple passive volume and tone controls) are used and not usually strayed from by the manufacturers. In some cases, pickups of both types are provided on the same instrument to allow more tonal variation and/or partially compensate for the tonality limitations of each pickup type.

Typical magnetic pickups found in almost all instruments of the past and today are of two basic design families or types-humbucking (e.g., U.S. Pat. No. 2,896,491A) and single coil (e.g., U.S. Pat. No. 4,220,069A). These have not changed in overall electrical and magnetic design architecture since the early 1950's, although there have been many specific construction variations which attempt to improve on certain limitations of each type or produce a more specialized tonality for a specific genre.

Traditional single coil pickups as a practical disadvantage have the general limitation of being susceptible to extraneous induced electromagnetic hum and noise from the environment. Traditional humbucking pickups generally do not generate “bright” electrical output with a tonal profile sufficiently emulating the tonality of single coil pickups, or, if designed for more high frequency content, are limited in low midrange frequency output, so the traditional “humbucker” tonality desired for certain genres is compromised or more difficult to produce with the external signal chain.

A typical instrument, representative of hundreds of models from dozens of manufacturers, is passive (i.e., does not contain active electronic circuitry which consumes battery or external power,) incorporates one or more pickups of a certain type or mixed types, and provides one or more sets of basic control circuits to allow the musician to attenuate overall electrical signal amplitude (“volume”) and (roughly speaking) overall high frequency content (“tone”) of the instrument's output signal.

The traditional volume control is universally used in passive instruments and serves its purpose more or less adequately. However, the traditional passive tone control design is well known to have serious limitations in the control of the lower midrange frequency content of the instrument signal, which is a key element in perceived tonality differences between single-coil and humbucking pickups and has been found to be only effective to achieve musically useful but limited tonality modification in a fractional part of its control range.

Having a wide range of available tonalities in a single electric guitar has always been a desirable goal, and this goal has been pursued in many ways over the decades in the design of instruments. This has been attempted with more or less success in prior art and practice, usually not by straying from the traditional pickup types and simple volume and tone control designs, but most commonly, by adding circuitry which provides switching means affecting pickup selection and output combinations of multiple pickups (e.g., phasing, series, parallel connection of two or more pickups located in different positions under the strings), combined with the conventional passive volume and tone control circuits.

Also, a specific technique is widely used in instruments available in the market and is seen with instruments with both passive and active electronics. This method modifies the output characteristics of the traditional humbucking pickup by operating the pickup in a way that the electrical output of one coil of the two internal coils comprising the circuit of the pickup can be partially or completely disabled by manual switching or other means (this is referred to as “coil splitting”). This functionality is provided on instruments to approximate the characteristic tonality of single-coil type pickups, for the intended goal of allowing an instrument with humbucking pickups, with possible minor external signal chain changes, to be used in musical performance in a genre calling for tonality associated with guitars using single-coil pickups.

This coil splitting means of changing the electrical properties, therefore tonality, of the traditional humbucking pickup, when provided on the instrument, has several well-known limitations in practice. These limitations are intrinsic to the prior art physical and electrical design of the humbucking pickup and can only be partially mitigated within the traditional design architecture and form factor. These are:
1. Coil splitting creates a substantial unwanted electrical signal output reduction from the pickup when the coil splitting is engaged, since the number of total coil turns is halved, via disabling of one of the 2 series connected coils of the pickup.
2. Coil splitting defeats the hum rejection functionality of the humbucking pickup, which requires two electrically balanced, out of phase coils to reduce the susceptibility of the pickup signal to outside environmentally induced electromagnetic hum and noise.
3. Coil splitting in humbucking pickups, even with extreme design effort, in most if not all cases, only imperfectly reproduces the single coil pickup tonality in conventional instruments with passive conventional volume and tone controls.

This third shortcoming above is due to two factors: first, the electrical characteristics (inductance, intrinsic/parasitic capacitance, coil resistance) of the single operating coil of the humbucker placed in coil splitting mode, and the volume and tone control component values which affect the tonality, typically do not completely emulate those of a single coil pickup and its tone/volume circuits, and secondly, the magnetization pattern (the shape and width of magnetic field intensity of the pickup which induces magnetism in the string at different points along the string) of the humbucking pickup, and coil location relative to this magnetic field geometry, is substantially different from that of a single-coil pickup, and these differences are exacerbated when coil split operation is selected.

In a conventional humbucking pickup, the string magnetization pattern (a.k.a. magnetic field geometry) of the conventional pickup is relatively wide, offset, and asymmetrical along the string length above the conventional pickup relative to the location of either one of the two coils operating in coil split mode, whereas a conventional single coil pickup has a symmetrical magnetization pattern along the string length, centered above the pickup coil, which is coincident with the pole piece or pole magnet. These differences in string magnetization pattern (in intensity, width, and offset) and relative coil location lead to differences in transduced electrical response to physical nodes and antinodes of harmonics of the string vibrations. These differences are most prominent when the pickup is located close to the guitar bridge. These in turn limit the ability of the conventional humbucking pickup, when coil split, to emulate a single-coil pickup in the same physical location under the strings. Also, higher eddy current losses inherent in the conventional humbucking pickup's physical and magnetic design, versus the single coil architecture, play a minor role in altering the frequency response of the conventional humbucking pickup in both coil split and normal humbucking modes, and this also constrains the desired single coil emulation.

The subject matter of the present disclosure is directed to overcoming, or at least reducing the effects of, one or more of the problems set forth above.

### SUMMARY OF THE DISCLOSURE

An electronic pickup assembly for a stringed instrument includes a base plate designed with two sides. Two sets of two ferrous rails or linear sets of pole pieces are disposed on the base plate and include: an inner pair and an outer pair. Each rail/pole set in the inner pair has a coincident coil wound around it, Adjacent to each rail/pole set of the inner pair is an outer rail/pole set. Each of these outer rails/pole sets also has a coincident coil, for a total of 4 coils for the assembly. On the second side of the base plate, the assembly has three permanent magnets. The first and second permanent magnets are positioned between the adjacent first and second rails/pole sets and are aligned with the same magnetic orientation transverse to the rails/pole sets. The intermediate permanent magnet is located between the first rails/pole sets, but it has a magnetic orientation that is opposite to that of the first and second magnets. The provisioning of the magnets and ferrous rails/poles can establish a symmetrical magnetic field geometry with alternating adjacent magnetic pole orientation, in which a significantly higher magnetic field strength (approximately 2×) is obtained above the inner pair of rails/pole sets versus the field strength above the outer pair of rails/pole sets. All of the four coils comprising both pairs of coils, the inner pair and the outer pair, can be identical in electrical and physical properties for manufacturing simplicity and can be electrically interconnected internally in the pickup assembly to provide a series humbucking configuration for the output of the outer pair of coils, and a separate parallel humbucking configuration for the output of the inner pair of coils. This creates two independent humbucking pickups in the disclosed assembly with substantially different electrical characteristics (such as inductance and DC resistance) as well as different physical spacing between the two coils and rails/poles comprising each humbucking coil pair. The two independent outputs of the disclosed pickup assembly (inner coil pair and outer coil pair) can be connected externally in a series electrical configuration to provide a single summed composite pickup output signal. An electrical network consisting of an RC network, minimally comprising a single resistor and a single capacitor, can be connected between the junction point of the outer and inner coil pair outputs, and ground. By selection of varying values of the RC network capacitance and resistance by either switching of the resistance and/or capacitance values, variable resistor means, or both, the variable RLC filter formed by the RC circuit in conjunction with the differing inductances of the two coil pairs can provide a single composite pickup electrical output in response to string vibrations which may be controlled over a wide range of frequency response (tonality) by the musician. The complete disclosed design can also provide a variable frequency-selective string aperture feature which derives from the combination of physical, magnetic, internal electrical, and external electrical design elements and is coincident with the control means. This feature can assist in obtaining more pleasing tonality over the range of adjustments provided by the control means. Additional fixed or variable passive circuitry may be provisioned to reduce the low frequency response and/or provide additional resonant frequency shift and high frequency control at one extreme of the range of adjustment. Alternate embodiments may use active electronic circuitry to provide a wider possible range of tonalities, buffering and/or amplification of the signal before the signal is output from the instrument.

The foregoing summary is not intended to summarize each potential embodiment or every aspect of the present disclosure.

### BRIEF DESCRIPTION OF THE DRAWINGS

FIGS. 1A-1B illustrates a top view and a side view of a pickup according to the present disclosure.

FIG. 2A illustrates a bottom view of the disclosed pickup.

FIG. 2B illustrates an isolated view of a magnet for the disclosed pickup.

FIG. 3 illustrates an end view of the disclosed pickup.

FIG. 4A illustrates an example of a 2-dimensional finite element magnetic simulation plot of field intensities and field contour lines of a model of the disclosed pickup.

FIG. 4B illustrates a detailed portion of the plot of FIG. 4A.

FIG. 5 illustrates one example of an electrical wiring scheme for the disclosed pickup.

FIG. 6 shows an example of a stringed instrument having an electronic pickup assembly and circuitry according to the present disclosure.

FIG. 7 illustrates an example of electrical control circuitry for used with the disclosed pickup.

FIG. 8 illustrates another example of electrical control circuitry for used with the disclosed pickup.

FIG. 9 illustrates yet another example of electrical control circuitry for used with the disclosed pickup.

FIG. 10 illustrates another configuration of FIG. 9.

### DETAILED DESCRIPTION

A variable reluctance magnetic pickup and electrical control circuitry of the present disclosure may be directed to one or more of the following:
(1) Facilitating an increased ability of the musician to control the tonality or overall frequency response of the electrical signal output generated from the musician's performance on the instrument's strings and transduced by the magnetic pickup(s),
(2) Substantially improving the musically useful range of tonalities (and subjective tone quality over the entirety of that range) of the instrument,
(3) Maintaining a hum-cancelling functionality without regard to external circuit configuration or tonality chosen to be produced,
(4) Maintaining as closely as possible a consistent overall perceived volume level of the instrument's output regardless of the musician's adjustment or selection of the tonality of the pickup signal, and
(5) Facilitating ease of physical and electrical retrofit into existing instruments equipped with prior art humbucking pickups and passive control circuitry.

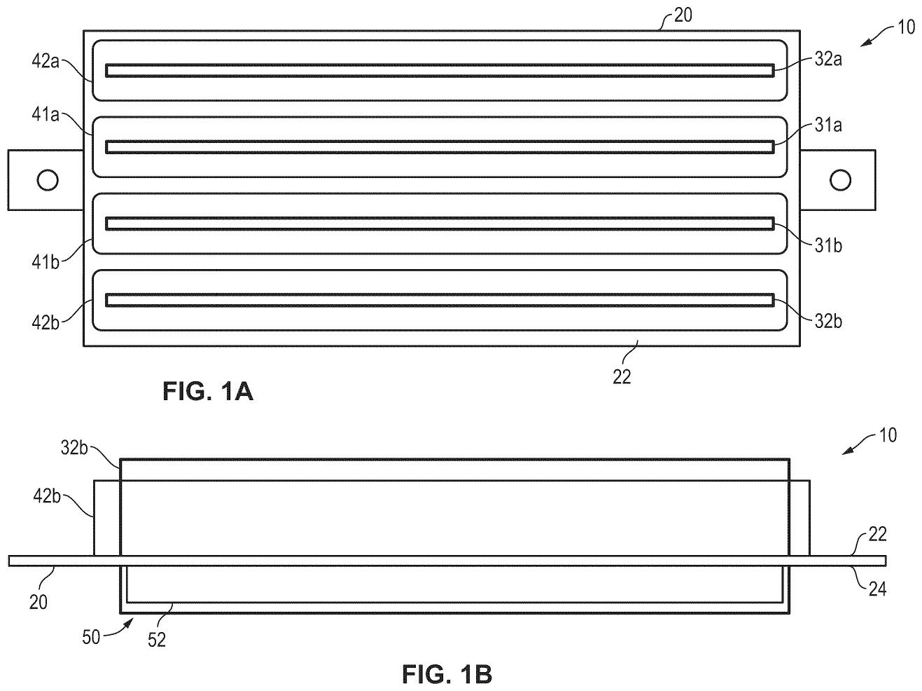

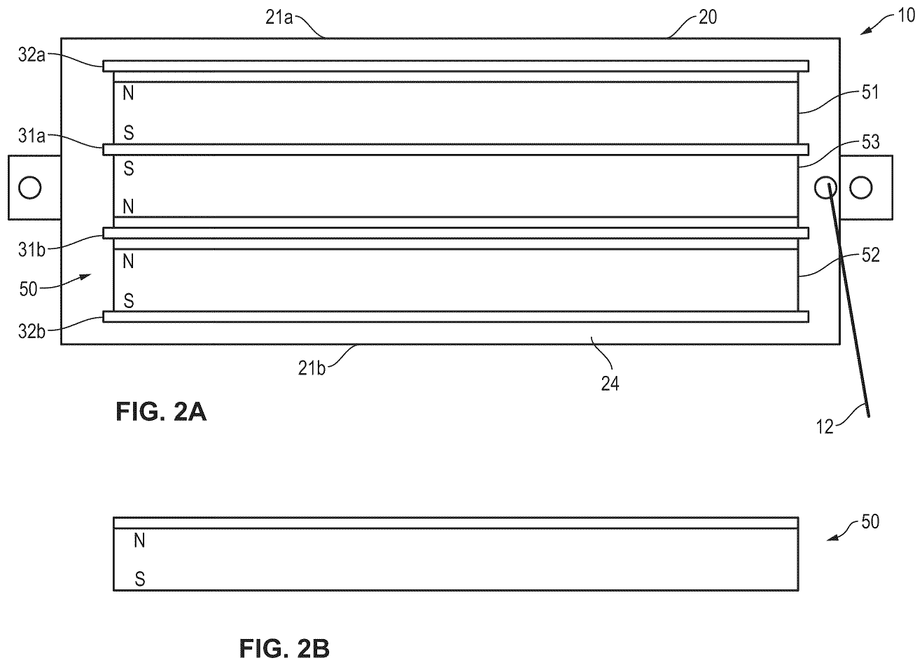

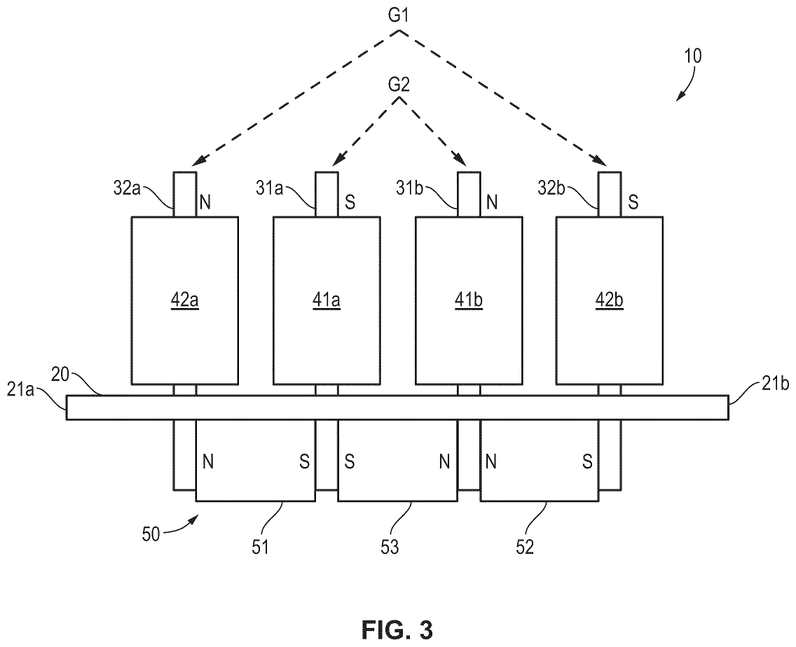

FIGS. 1-3 and 6 show an electronic pickup assembly 10, which can be used for a stringed instrument. FIG. 1 shows a top view and a side view of one configuration of the electronic pickup assembly 10 according to the present disclosure, and FIG. 2 shows a bottom view of the disclosed pickup assembly 10 showing placement of rails 31a-b, 32a-b and permanent magnets 51, 52, 53. Meanwhile, FIG. 3 shows an end view of the disclosed pickup assembly 10, showing the arrangement of permanent magnets 51, 52, 53 and rails 31a-b, 32a-b.

The electronic pickup assembly 10 comprises a base plate 20, an inner pair 30a of first rails 31a-b, an outer pair 30b of second rails 32a-b, a first permanent magnet 51, a second permanent magnet 52, and an intermediate permanent magnet 53. The base plate 20 has first and second sides (e.g., a top side 22 and a bottom side 24). The inner pair 30a of first rails 31a-b are disposed adjacent to one another in the base plate 20. Each of the first rails 31a-b has a first coil 40a-b wound thereabout on the first side 22 of the base plate 20. The first coils 40a-b are electrically connected in parallel and are configured to provide a first independent output. The outer pair 30 of second rails 32a-b are also disposed in the base plate 20. Each of the second rails 32a-b are disposed adjacent to one of the first rails 31a-b of the inner pair 30a. Each of the second rails 32a-b has a second coil 42a-b wound thereabout on the first side 22 of the base plate 20. The second coils 42a-b are electrically connected in series and are configured to provide a second independent output.

The first permanent magnet 51 is disposed on the second side 24 of the base plate 20 between a first set of the first and second rails (i.e., 31a, 32a), which are adjacent to one another. The first permanent magnet 51 has a first magnetic orientation (N-S) transverse to the respective rails 31a, 32a. The second permanent magnet 52 is disposed on the second side 24 of the base plate 20 between a second set of the first and second rails (i.e., 31b, 32b), which are adjacent to one another. The second permanent magnet 52 also has the first magnetic orientation (N-S) transverse to the respective rails 31b, 32b. The intermediate permanent magnet 53 is disposed on the second side 24 of the base plate 20 between the first rails 31a-b, which are adjacent to one another. The intermediate permanent magnet 53 has a second magnetic orientation (S-N) opposite to the first magnetic orientation (N-S).

The base plate has front and back edges 21a-b opposed to one another to which the first and second rails 31a-b, 32a-b are arranged parallel. In one configuration as shown in FIGS. 2 and 3, the first magnetic orientation has a North pole toward the front edge 21a and a South pole toward the back edge 21b, and the second magnetic orientation has a South pole toward the front edge 21a and a North pole toward the back edge 21b. In an alternative configuration, the first magnetic orientation has a South pole toward the front edge 21a and a North pole toward the back edge 21b, and the second magnetic orientation has a North pole toward the front edge 21a and a South pole toward the back edge 21b.

In any of the disclosed arrangements, each of the first and second rails 31a-b, 32a-b can share geometric and ferrous characteristics, and each of the permanent magnets 51, 52, 53 can share geometric and magnetic characteristics. In any of the disclosed arrangements, the first rails 31a-b can have a first magnetic field strength that is approximately twice a second magnetic field strength of the second rails 32a-b.

Overall, the physical configuration of the disclosed pickup assembly 10 includes four rails/pole piece sets 31a-b, 32a-b and a coil configuration 41a-b, 42a-b. In particular, the physical structure and associated magnetic field configuration of the disclosed pickup assembly 10 includes ferrous linear sets of pole pieces (or single-piece “rails”) 31a-b, 32a-b in conjunction with an arrangement of permanent magnets 51, 52, 53. In one configuration, the permanent magnet arrangement uses three identical permanent magnets 51, 52, 53 with a defined orientation and uses four identical single rails 31a-b, 32a-b, which are designed to provide a set of magnetic fields above the top of the disclosed pickup assembly 10. The magnetic fields primarily originate and terminate in the rails 31a-b, 32a-b.

FIG. 3 shows an end view of the disclosed pickup assembly 10. An example magnet orientation of the permanent magnets 51, 52, 53 is also shown that can produce higher field strength at the inner two rails 31a-b. As will be shown, the magnetic field strength (G2) measured at the top of the two inner rails 31a-b is approximately twice that of the outer rails 32a-b (G1) because of the arrangement and orientation of opposite magnetic poles of the three permanent magnets 51, 52, 53.

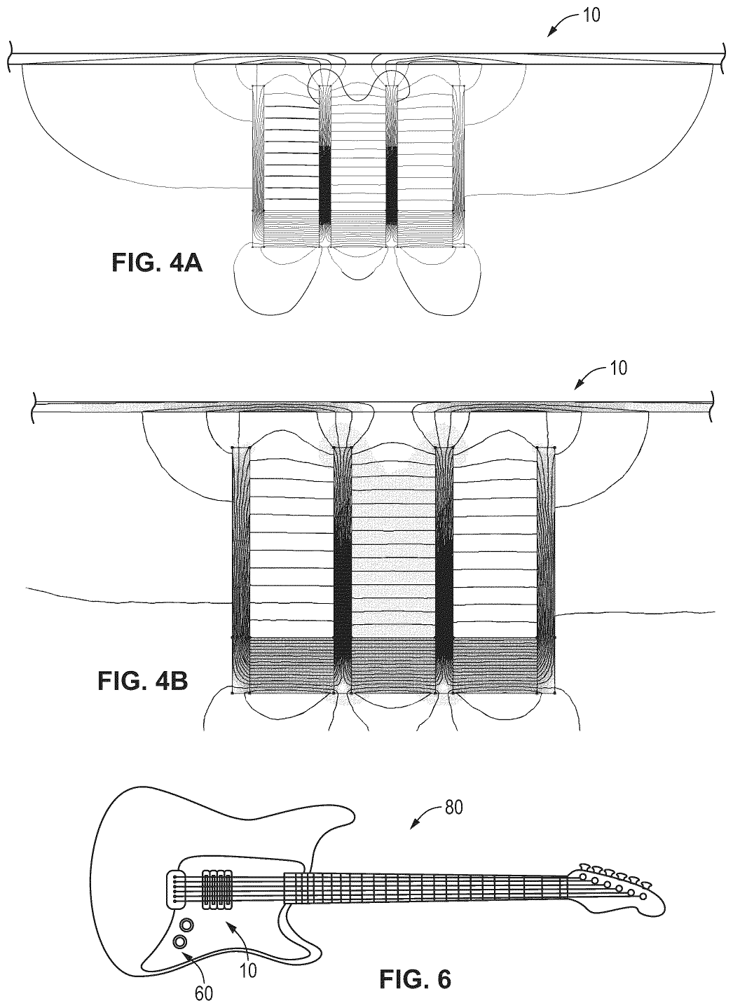

These magnetic fields form a composite magnetic field that is symmetrical with respect to the normal centerline of the pickup's top face in a parallel plane of the string set, as shown by FIG. 4A and FIG. 4B. The magnetic fields also alternate in the magnetic polarity of adjacent rails or pole sets 31a-b, 32a-b to allow humbucking operation of the pickup coils, as is shown by FIG. 3.

The field intensity directly above each of the inner two pole sets/rails 31a-b and outer pole sets/rails 32a-b is defined by construction and orientation of the permanent magnets 51, 52, 53. The magnetic field intensity (G2) in Gauss for the inner set of two rails 31a-b in a manufactured example of the pickup assembly using 3 identical ceramic composition magnets can be 800 to 900 Gauss, while the magnetic field intensity (G1) in Gauss for the outer set of two rails 32a-b can be 400 to 450 Gauss as measured at the top of each of the four rails 31a-b, 32a-b.

The field intensities noted above are accomplished by the physically adjacent arrangement of the three identical permanent magnets 51, 52, 53 and the four identical rails 31a-b, 32a-b in the following configuration, as shown in FIG. 3:

(PP)-(N)-(S)-(PP)-(S)-(N)-(PP)-(N)-(S)-(PP)

where (PP) refers to the pole piece set or rail, (N) refers to the north magnetic pole of the permanent magnet, and(S) refers to the south pole.

An alternative can be configured by reversing the polarities of the permanent magnets 51, 52, 53, as follows:

(PP)-(S)-(N)-(PP)-(N)-(S)-(PP)-(S)-(N)-(PP).

Although certain ratios and values of magnetic field intensity are described here, other ratios and values of magnetic field intensity are possible. For example, the disclosed pickup assembly 10 implemented with different compositions and sizes of permanent magnets 51, 52, 53, pole piece/rail composition and dimensions, pole piece/rail spacings, and different magnet placement and orientation, can produce other ratios of magnetic field intensity and absolute field strengths suitable for the purposes of the present disclosure.

For further reference, FIG. 4A is a 2-dimensional finite element magnetic simulation plot of example field intensities and field contour lines for a model of the disclosed pickup assembly 10 with the magnet composition and orientations provisioned as described. FIG. 4B is a zoomed version of the plot image of FIG. 4A. The plot has been generated using the software package FEMM 4.2. A simulated ferrous metallic string is modeled at 0.125″ above the disclosed pickup assembly, and pickup geometry is modeled to be representative of a manufactured configuration of the disclosed pickup assembly.

As shown in FIGS. 1 to 3, the disclosed pickup assembly 10 includes multiple pickup coils 41a-b, 42a-b having a physical arrangement, electrical characteristics, and electrical interconnection. In particular, the disclosed pickup assembly 10 includes four adjacent pickup coils 41a-b, 42a-b, functionally grouped as two independent pairs of coils that include an inner pair 41a-b and an outer pair 42a-b. Each coil 41a-b, 42a-b is assembled as coincident with and surrounding one of the four ferrous pole sets or rails 31a-b, 32a-b. Each coil pair 41a-b, 42a-b is configured so that the two coils of each pair 41a-b, 42a-b are electrically interconnected in a humbucking configuration. The inner pair of coils 41a-b are coincident with the more intense magnetic field of the inner two rails/pole sets 31a-b. The inner pair of coils 41a-b can be manufactured and/or configured with substantially lower total inductance and winding count relative to the outer two coils 42a-b.

This may be accomplished for ease of manufacture by making all four coils 41a-b, 42a-b identical (within a small manufacturing tolerance) and configuring the outer two coils 42a-b in series humbucking mode, and the inner two coils 41a-b in parallel humbucking mode. This results in a 4:1 ratio of inductance and DC resistance, and 2:1 ratio of number of coil turns, of the outer coil pair 42a-b versus the inner coil pair 41a-b.

Ratios exceeding 1:1 of inductance between the outer and inner coil pairs 41a-b, 42a-b can be accomplished according to the present disclosure using alternate constructions, including differing counts of winding turns, wire diameter, coil dimensions, etc. of the outer coils 42a-b versus the inner coil 41a-b construction parameters.

The more intense magnetic field strength associated with the inner two rails 31a-b, combined with the lower winding count and inductance of the associated inner two coils 41a-b, can be provisioned to provide an approximate match in overall electrical transduced output signal level of the inner coil pair 41a-b relative to the output signal level of the outer coil pair 42a-b, or to provide a similar ratio of output signal levels of the two coil pairs which is suitable for functionality of the disclosed pickup assembly 10 in conjunction with the disclosed external electrical control circuits 60.

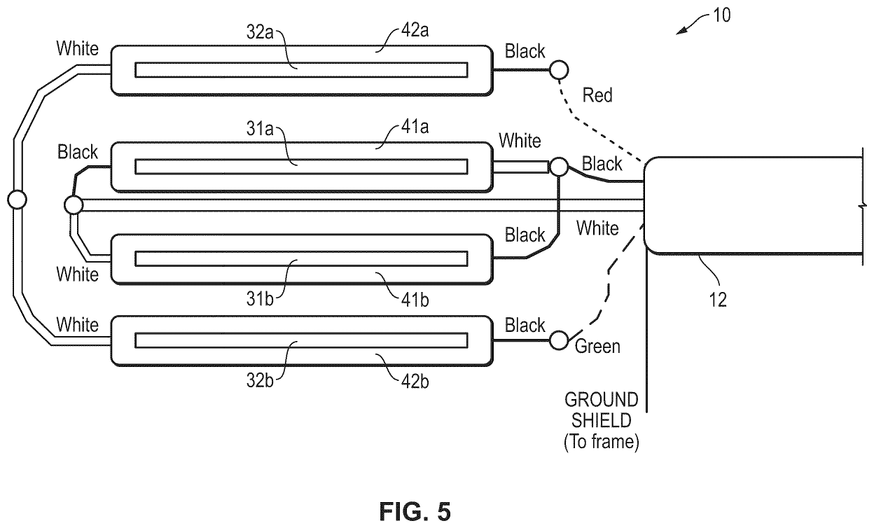

FIG. 5 shows an example electrical wiring scheme of the four coils 41a-b, 42a-b of the disclosed pickup assembly 10 and a connecting cable 12. The example wiring scheme illustrates both a series humbucking connection of the outer coils 42a-b and a parallel humbucking connection of the inner coils 41a-b. The inner coil 41a is assembled in reverse. This drawing also illustrates that both coil pairs 41a-b, 42a-b can be connected separately to the connecting cable 12. The inner coil pair 41a-b uses black and white wires of the connecting cable 12, and the outer coil pair 42a-b uses green and red wires of the connecting cable 12.

Each coil pair 41a-b, 42a-b is connected, and electrical outputs brought out on the connecting cable 12, independently of the other coil pair 41a-b, 42a-b, so there are two functionally independent humbucking pickups present, substantially differing in electrical characteristics (e.g., inductance, source impedance, etc.) and differing in physical spacing between the pole sets/rails 31a-b, 32a-b, in the complete assembly of the disclosed pickup assembly 10.

Each coil pair's output signal may be electrically connected, amplified, and/or processed completely separately from the output signal of the other coil pair 41a-b, 42a-b.

The two outer or two inner coils that together comprise each coil pair, either 41a-b or 42a-b, are configured to be identical (or at least nearly identical) in construction and electrical properties and are interconnected inside the disclosed pickup assembly 10 in a humbucking configuration, either series or parallel. Therefore, any form of external circuit configuration may not defeat or compromise the hum/noise rejection functionality of the disclosed pickup assembly 10.

According to the present disclosure, a connection method is disclosed herein for the two coil pair outputs and associated external electrical circuit. In the connection method, an electrical circuit configuration can combine the two (outer pair and inner pair 41a-b, 42a-b) pickup outputs in a series configuration to provide a single summed composite pickup electrical output.

A stringed instrument, such as an electric guitar, an electric bass, and the like, can include an electronic pickup assembly 10 according to any one of the disclosed arrangements. FIG. 6 shows an example of a stringed instrument 80 having an electronic pickup assembly 10 and electrical control circuitry 60 according to the present disclosure. The electrical control circuitry 60 onboard such a stringed instrument 80 can allow the musician to manually change the composite pickup output transduced frequency response to string vibrations by providing simultaneous control of: 1) the overall composite pickup electrical output source impedance, affecting output levels of the higher transduced frequencies, 2) the relative output level of the midrange frequencies, and 3) the width of the linear region above the center of the top face of the pickup of the highest sensitivity of the pickup to string vibrations (known as “string aperture”) in a frequency-selective manner. Such frequency selectivity can depend upon the fundamental and harmonic frequencies generated by vibrations of each string and the degree of action of the control means.

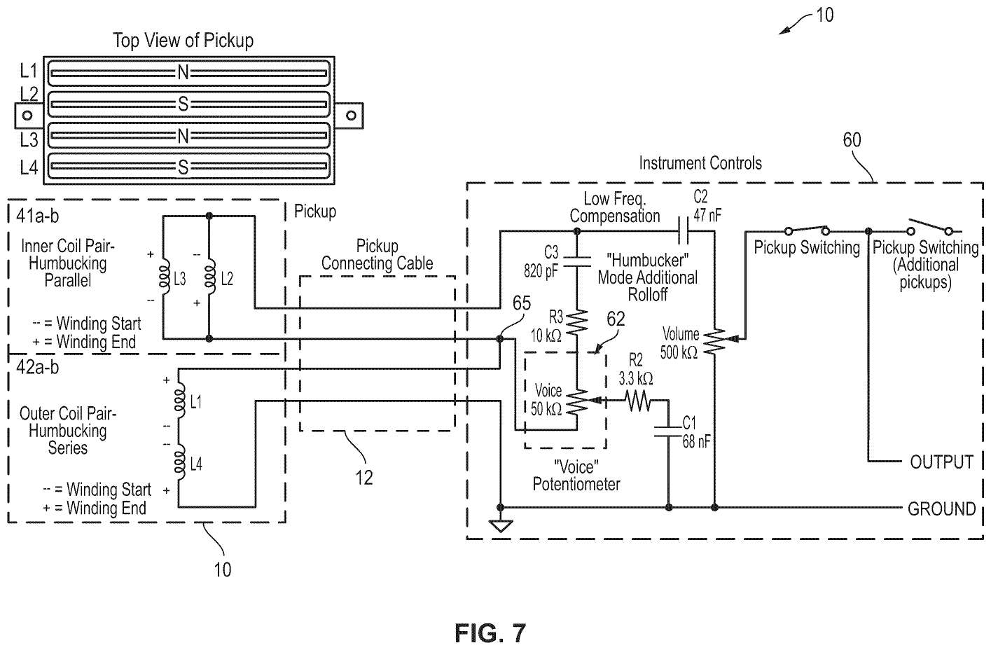

In one configuration, the electrical control circuitry 60 can provide variable electrical loading of the outer coil pair 42a-b's signal relative to the inner coil pair 41a-b's signal in the composite pickup output. As shown in FIGS. 7 through 10, the electronic pickup assembly 10 can further comprise electrical control circuitry 60 in electrical communication with the first and second independent outputs. The electrical control circuitry 60 can include a first-order Resistor-Capacitor (RC) network having a variable resistive component (62) and a first capacitor (C1). The variable resistive component (62) is connected to a junction 65 and is configured to provide a variable resistance. The junction 65 connects (i) one of two ends of the first independent output for the first (inner) coils 41a-b electrically connected in parallel, and (ii) one of two ends of the second independent output for the second (outer) coils 42a-b electrically connected in series. The first capacitor (C1) is connected between the variable resistance and a ground of the control circuitry 60.

As shown in each of FIGS. 7 to 10, the control circuitry 60 can also include: a second capacitor (C2) connected to the other end of the first independent output for the first coils 41a-b; and a second variable resistor having a resistive element and a variable output. The resistive element is connected between the second capacitor (C2) and the ground, and the variable output is configured to connect to an output of the control circuitry 60. The other end of the second independent output for the second coils 42a-b is connected to the ground.

As shown in the example of FIG. 7, the variable resistive component 62 can include a first variable resistor having an input terminal of a resistive element and having an output terminal in variable electrical contact relative to the resistive element. The input terminal is connected to the junction 65. The first capacitor (C1) is connected between the output terminal of the variable resistor and the ground of the control circuitry 60.

In the example of FIG. 7, the electrical control circuitry 60 can provide variable tonality features of the disclosed pickup assembly 10. In this example, a potentiometer labelled “Voice” controls the “voicing’ or tonality of the pickup output. Resistor R2 sets a typical minimum value for the midrange frequencies. Capacitor C1 is the other component of the RC network with R2. Capacitor C2 provides bass roll-off compensation for the pickup output.

The external first-order passive RC network is connected between the junction point of the inner coil pair 41a-b and the outer coil pair 42a-b in the series configuration, and ground. (The inner coil pair 41a-b is schematically shown in an upper region, and the outer coil pair 42a-b is schematically shown in a lower region merely for illustrative purposes). In conjunction with the inductances of both coil pairs 41a-b, 42a-b, this RC network also forms a type of RLC notch filter, acting on the overall composite pickup transduced electrical signal output.

Given a fixed set of coil pair inductances, the RLC notch filter can be tuned to operate in the lower midrange frequencies primarily by the capacitance value selected for the RC network. Moreover, the depth of the notch filtering depends on the resistance value of the RC network.

Larger values of the RC network resistance can produce less notch filtering and increased midrange frequency content, and smaller values of the resistance can produce more notch filtering and less midrange frequency content.

In practice, with the choice of appropriate values of pickup coil pair inductances and an appropriately chosen fixed capacitor value in the RC network, a substantial range of control is achieved over the level of a range of midrange frequencies of the transduced signal output of the composite pickup. The control can be achieved by varying only the resistance value of the external RC network from some minimum value (which can include zero ohms) to some maximum value typically less than 100K ohms, by either switching between different values of fixed resistors, a potentiometer, or both.

FIG. 7 also shows the basic circuit operation described, with the addition of one resistor R3 and a capacitor C3, which provide additional tone shaping and lowering of the resonant frequency of the composite pickup when the “Voice” potentiometer wiper is rotated away from the junction 65 of the inner and outer coil pairs 41a-b, 42a-b. This can provide a smoother transition from “single-coil” to “humbucker” type tonal characteristics over the range of potentiometer adjustment and facilitates more independent adjustment of the “humbucker voice” output frequency balance by means of the provision of the values of R3 and C3.

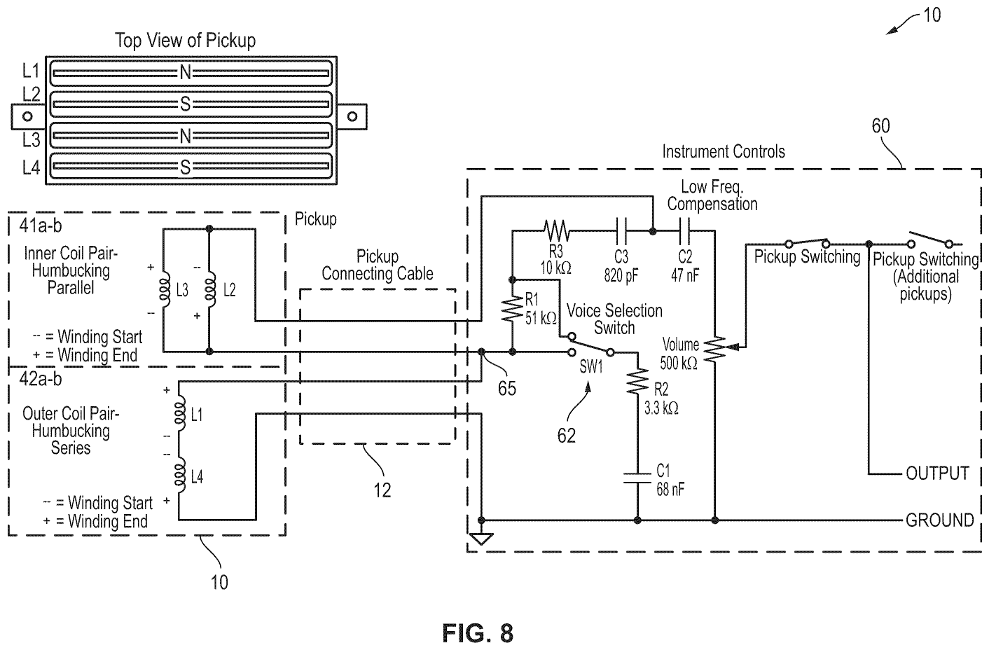

As shown in the example of FIG. 8, the variable resistive component 62 can include a resistor element and a selective switch connected in parallel between the junction 65 and the first capacitor (C1). The selective switch is configured to select the variable resistance.

In the example of FIG. 8, this electrical control circuitry 60 can provide variable tonality features of the disclosed pickup assembly 10. Here, tonalities may be preset using a variable resistor and a switch. Closing the switch bypasses resistor R1 and leaves only R1 and R2 in circuit, and reduces the effect of R3 and C3, which sets a “single coil” like tonality. Opening the switch adds resistance to the RC circuit formed with C1 and changes the tonality for more midrange response and lowered high frequency content, characterized as “humbucker” tonality, and provides a lower impedance to ground for the R3 and C3 components, additionally reducing the resonant frequency peak and attenuating more high frequencies. A mixture of preset and variable resistance circuitry can be used in alternate arrangements. Bass compensation capacitor C2 can also be included in this example.

The pickup assembly 10 is configured so that, without the addition of the external RC network and if the coil pair outputs are connected in series, the additive inductances of the two coil pairs cause a lower fixed resonant frequency of the composite pickup, and the summed outputs of the two pickup coil pairs 41a-b, 42a-b may substantially overlap and reinforce in the midrange frequencies. Therefore, without the RC network, the composite pickup assembly 10 can produce a signal with a tonally undesirable frequency balance excessively favoring the midrange.

Although the composite pickup assembly 10 could be operated without an external RC network, the disclosed pickup assembly 10 may preferably be operated with an external RC network as discussed. Accordingly, the RC network is preferably connected to the junction 65 of the two coil pairs 41a-b, 42a-b, and subsequently the RLC filter to a greater or lesser degree may always operate in notch filtering the midrange frequencies and modifying the resonant peak of the disclosed pickup assembly 10. This can result in the designed control range of tonality with the disclosed electrical control circuitry 60.

Coincident with the RLC notch filter action, an increase in the variable shunting of the greater outer coil pair source impedance with the RC network can also provide a corresponding reduction in the effective net composite pickup output source impedance at midrange to high frequencies because of the substantial source impedance difference between the outer coil pair (higher source impedance) and the inner coil pair (much lower source impedance.) Lowering the source impedance of the disclosed pickup assembly 10, coincident with reducing the midrange frequency content, can allow greater high frequency signal output into the combined load impedances of the volume control, connecting cable, and amplifier/signal processor input circuits.

Therefore, by varying a single resistance value in the RC network by a control potentiometer and/or a switched resistor, substantial control can be achieved in a variable and/or pre-set manner of both the relative midrange and (as a secondary effect) high frequency content of the pickup electrical output into the signal chain.

This can produce a wide range of tonalities of the disclosed pickup assembly 10 and can facilitate rapid adjustment at the instrument of tonality of the instrument through the entire signal chain with a single control action by the musician during performance.

Design values of the two sets of coil pair electrical parameters, the RC network, and the resistance control can be chosen to optimize a range of musically pleasing tonalities that are possible and available to the musician.

In alternate configurations, this functionality of controlling frequency response may be achieved using other passive or active circuitry or digital signal processing techniques, and may act on both coil pair outputs, separately or together, to produce single or multiple output signals.

A feature of the disclosed configuration is a variable string aperture that statically narrows with increasing frequency and also narrows further with decreasing midrange frequency level controlled by the control techniques disclosed. (The string aperture is defined as the width of the linear region of the most sensitivity (highest output in response to string vibrations) of the pickup assembly 10 at a given frequency, parallel to the plane axis of the strings and centered on the centerline of the top face of the pickup assembly normal to the string direction.) Although this variable aperture effect may be a secondary effect, it can assist in producing more pleasing tonalities within a range of tonalities as the “voicing” of the pickup assembly is changed by the disclosed control techniques.

This widening or narrowing of the aperture width takes place within the physical spacing limits of the outer and inner coil pair pole pieces/rails 31a-b, 32a-b and the magnetic field geometry and is enabled by the outer coil pair 42a-b with physically wider spacing of the its coincident pole pieces/rails 32a-b, versus the inner coil pair 41a-b with narrower spacing of its coincident pole pieces/rails 31a-b.

The effective string aperture of the disclosed pickup assembly 10 depends upon the ratio of the outer coil pair signal output to the inner coil pair signal output at any given frequency due to the “concentric” arrangement of inner and outer coil pairs, and therefore varies not only with the fundamental and harmonic frequencies generated by the vibrating strings and the intrinsic electrical characteristics of both coil pairs, but also upon the variable filtering action of the RC network upon the outer coil pair. As the RC network resistance value decreases by control action, the output of the outer coil pair 42a-b decreases more quickly relative to the inner coil pair 41a-b at midrange and higher frequencies because of the frequency-dependent shunting of the outer coil output by the RC network to ground. Sensitivity to midrange and higher frequencies is not proportionally reduced for the inner coil pair during this control action even as RLC notch filtering is made more active, because of the output configuration and the source impedance differences of the two coil pairs 41a-b, 42a-b.

The net effect is that as the pickup assembly 10 is tuned for a more single coil-like tonality (e.g., by reducing the RC network resistance component), the string aperture width for midrange and higher frequencies is narrowed to be more coincident with the inner set of rails/poles 31a-b and subsequently more closely resembles the narrower string aperture width of a traditional single-coil pickup. Conversely, as the composite pickup assembly 10 is tuned for more midrange output (characteristic of a traditional humbucking pickup), there is less filtering of the outer coil pair output, and therefore the effective string aperture of the composite pickup assembly 10 for midrange and higher frequencies produced by the string is made wider, which more closely resembles the wider string aperture width of a traditional humbucking pickup.

The electrical control circuitry 60 may not affect the lowest transduced fundamental frequencies (below 200 Hz) of the lowest pitched strings to the same degree as the midrange and higher frequencies. In the disclosed configurations, both coil pairs 41a-b, 42a-b are contributing close to their full possible signal level in the composite pickup assembly 10 for those “bass” frequencies. This can result in a moderately higher and more consistent signal level of low frequencies relative to the midrange and highs over the range of tonalities provided by the control circuitry. As will be appreciated, this effect can depend on both physical construction (pole set/rail spacing) and electrical characteristics of the coil pairs 41a-b, 42a-b.

This relatively constant low frequency level may in fact be desirable for many genres but also can be easily compensated for if desired by equalization controls that are typically provided as part of an amplifier or effects unit in more direct and relatively non-distorted signal chains. The higher relative level of bass frequencies produced, however, may not be as desirable for certain amplifiers and signal chains, for example, those operating with higher gain and distortion levels to produce the desired voicings typical of certain genres.

Therefore, a moderate degree of fixed low frequency equalization may be provided in the control circuitry 60 of the disclosed pickup assembly 10. This can ensure the most desirable general frequency balance between lows, midrange, and highs over the range of tonalities provided by the control means, through the largest variety of amplifiers/signal chains.

Low frequency compensation/roll off below approximately 200 Hz may be provided by a high-pass RC filter which consists of a single capacitor C2 acting in conjunction with the passive volume control, as shown in FIGS. 7 and 8.

In alternate arrangements, this bass frequency compensation may be replaced with a potentiometer variable or switched bypass of a capacitor to provide “bass cut,” which can be adjusted in concert or separately with the other controls disclosed herein. The bypass can provide additional control of the levels of bass frequencies, which can provide more control of tonality at higher levels of gain and distortion with specific amplifier models and/or signal chains.

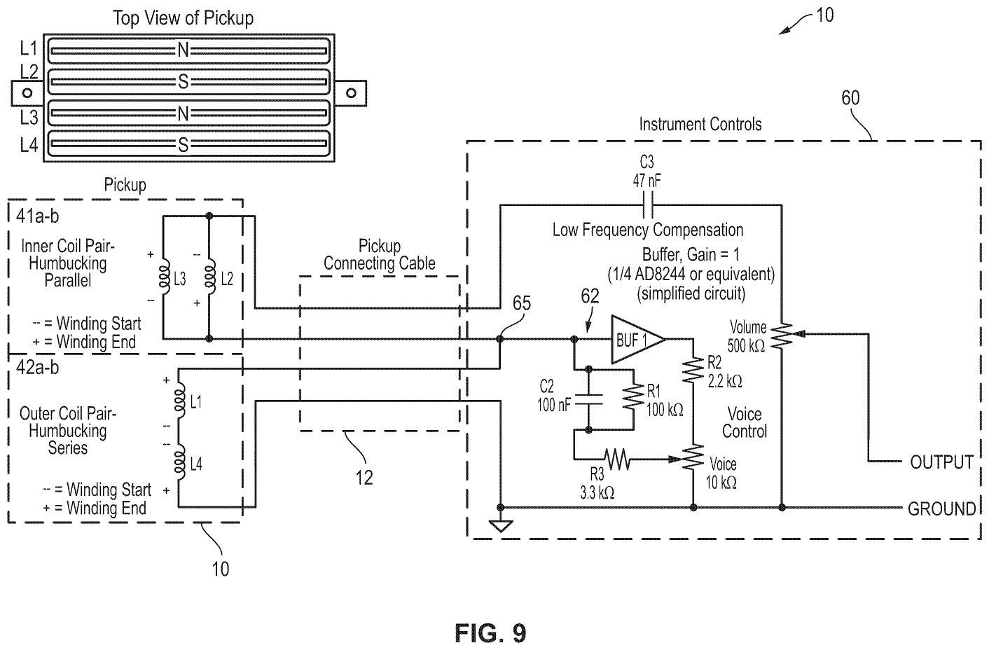

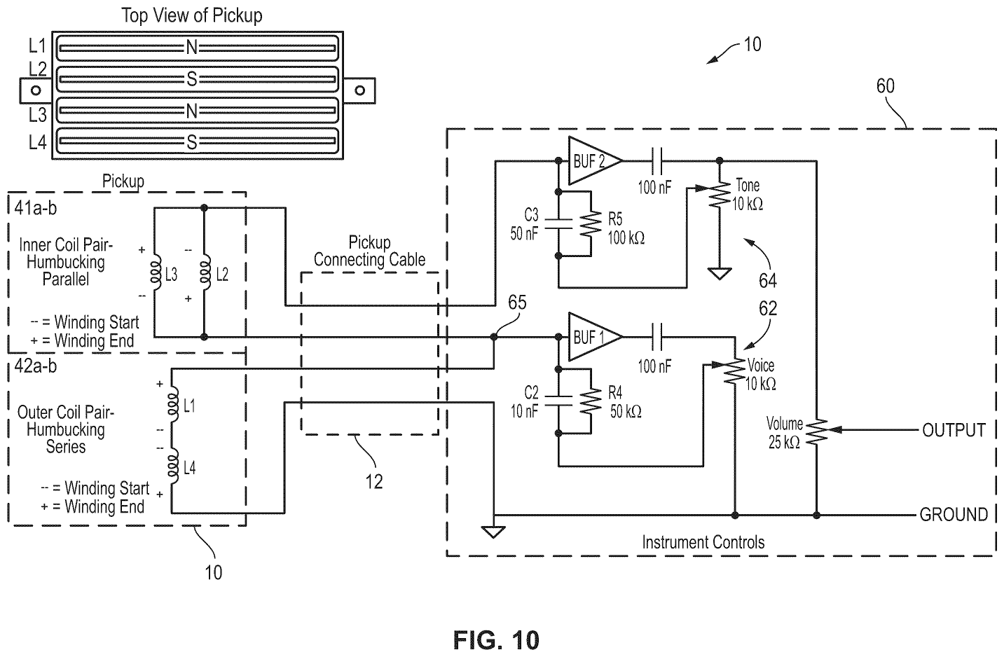

As shown in the examples of FIGS. 9 and 10, the RC network impedance may be controlled by an active buffer circuit. In particular, FIG. 9 shows yet another alternate example of control circuitry 60 to provide variable tonality features of the disclosed pickup assembly 10. Either the resistance or the capacitance value, or both, of the RC network can be actively controlled. In FIG. 9, an active buffer (gain=1.0) is used in a circuit topology known as “bootstrapping” to provide simultaneous control of resistance and capacitance of the RC network.

As shown in FIG. 10, the electrical control circuitry 60 can also include: an active buffer circuit 64 connected to the other end of the first independent output for the first coils 41a-b; and a second variable resistor having a resistive element and a variable output. The resistive element is connected between the active buffer circuit 64 and the ground, and the variable output is configured to connect to an output of the control circuitry 60. The other end of the second independent output for the second coils 42a-b is connected to the ground.

FIG. 10 shows a “bootstrap” configuration of FIG. 9 applied to both the outer coil pair 42a-b, and the composite pickup output signal. This adds an additional buffer which not only isolates the pickup from external load impedances but also provides an additional “Tone” control which is active on the composite pickup output, or the overall instrument output with multiple pickups, in changing overall load capacitance and/or load resistance. The buffers can use ¼ AD8244 or equivalent plus DC blocking/bias setting components.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. An electronic pickup assembly for a stringed instrument, the electronic pickup assembly comprising:
a base plate having first and second sides;
an inner pair of first rails disposed adjacent to one another in the base plate, each of the first rails having a first coil wound thereabout on the first side of the base plate, the first coils having a first inductance and being configured to provide a first independent output;
an outer pair of second rails disposed in the base plate, each of the second rails disposed adjacent to one of the first rails of the inner pair, each of the second rails having a second coil wound thereabout on the first side of the base plate, the second coils having a second inductance and being configured to provide a second independent output, the first inductance of the first coils being less than the second inductance of the second coils;
a first permanent magnet disposed on the second side of the base plate between a first set of the first and second rails adjacent to one another, the first permanent magnet having a first magnetic orientation transverse to the respective rails;
a second permanent magnet disposed on the second side of the base plate between a second set of the first and second rails adjacent to one another, the second permanent magnet having the first magnetic orientation transverse to the respective rails; and
an intermediate permanent magnet disposed on the second side of the base plate between the first rails adjacent to one another, the intermediate permanent magnet having a second magnetic orientation opposite to the first magnetic orientation.

2. The electronic pickup assembly of claim 1, wherein the first coils are electrically connected in parallel; wherein the second coils are electrically connected in series; and wherein the first coils have a first set of coil turns being approximately equivalent to a second set of coil turns for the second coils, whereby the first inductance of the first coils is less than the second inductance of the second coils.

3. The electronic pickup assembly of claim 1, wherein the first coils and the second coils are electrically connected in series; and wherein the first coils have a first set of coil turns being approximately less than a second set of coil turns for the second coils, whereby the first inductance in terms of the coil turns for the first coils is less than the second inductance in terms of the coil turns for the second coils.

4. The electronic pickup assembly of claim 1, wherein one of:
each of the first and second rails have an equivalent spacing from one another; and
the first rails of the inner pair have a first spacing, each of the second rails of the outer pair having a second spacing relative to the respective first rail adjacent thereto, the first spacing being different from the second spacing.

5. The electronic pickup assembly of claim 1, wherein the base plate has a front edge and a back edge opposed to one another to which the first and second rails are arranged parallel; and wherein:
the first magnetic orientation has a North pole toward the front edge and a South pole toward the back edge, and the second magnetic orientation has a South pole toward the front edge and a North pole toward the back edge; or
the first magnetic orientation has a South pole toward the front edge and a North pole toward the back edge, and the second magnetic orientation has a North pole toward the front edge and a South pole toward the back edge.

6. The electronic pickup assembly of claim 1, further comprising control circuitry in electrical communication with the first and second independent outputs.

7. The electronic pickup assembly of claim 6, wherein the control circuitry comprises a first-order Resistor-Capacitor (RC) network comprising:
a junction in electrical communication with (i) one of two ends of the first independent output for the first coils electrically connected in parallel, and (ii) one of two ends of the second independent output for the second coils electrically connected in series;
a variable resistive component in electrical communication with the junction and being configured to provide a variable resistance; and
a first capacitor in electrical communication between the variable resistance and a ground of the control circuitry.

8. The electronic pickup assembly of claim 7, wherein the other end of the second independent outlet is in electrical communication with the ground of the control circuitry; and wherein the control circuitry comprises:
a second capacitor connected to the other end of the first independent output for the first coils; and
a second variable resistor having a resistive element and a variable output, the resistive element connected between the second capacitor and the ground, the variable output being configured to connect to an output of the control circuitry.

9. The electronic pickup assembly of claim 6, wherein the control circuitry comprises:
a junction in electrical communication with (i) one of two ends of the first independent output for the first coils electrically connected in parallel, and (ii) one of two ends of the second independent output for the second coils electrically connected in series;
a first variable resistor having first and second terminals of a resistive element and having a third terminal in variable electrical contact relative to the resistive element, the first terminal in electrical communication with the junction, the second terminal in electrical communication with the other end of the first independent output; and
a first capacitor in electrical communication between the third terminal of the first variable resistor and a ground of the control circuitry.

10. The electronic pickup assembly of claim 9, comprising a resistor and a second capacitor connected in series between the second terminal and the other end of the first independent output.

11. The electronic pickup assembly of claim 9, comprising a resistor connected in series between the third terminal and the first capacitor.

12. The electronic pickup assembly of claim 6, wherein the control circuitry comprises:
a junction in electrical communication with (i) one of two ends of the first independent output for the first coils electrically connected in parallel, and (ii) one of two ends of the second independent output for the second coils electrically connected in series;
a first capacitor in electrical communication with a ground of the control circuitry; and
a selective switch and at least one resistor in electrical communication between the junction and the first capacitor, the selective switch being configured to select a variable resistance.

13. The electronic pickup assembly of claim 12, wherein the selective switch comprises:
a first terminal in electrical communication with the junction, the junction connected to a first of the at least one resistor in electrical communication with the other end of the first independent output;
a second terminal connected between the first resistor and the other end of the first independent output; and
a pole in electrical communication with the first capacitor and configured to selectively switch between the first and second terminals.

14. The electronic pickup assembly of claim 13, comprising a second resistor connected in series between the pole and the first capacitor.

15. The electronic pickup assembly of claim 12, comprising a second capacitor connected in series between the selective switch and the other end of the first independent output.

16. The electronic pickup assembly of claim 6, wherein the control circuitry comprises:
a junction in electrical communication with (i) one of two ends of the first independent output for the first coils electrically connected in parallel, and (ii) one of two ends of the second independent output for the second coils electrically connected in series;
a first active buffer circuit having an input and an output, the input in electrical communication with the junction;
a parallel resistor-capacitor circuit in electrical communication with the input; and
a first variable resistor having first and second terminals of a resistive element and having a third terminal in variable electrical contact relative to the resistive element, the first terminal in electrical communication with the output, the second terminal in electrical communication with a ground of the control circuitry, the third terminal in electrical communication with the parallel resistor-capacitor circuit.

17. The electronic pickup assembly of claim 6, wherein the control circuitry comprises:
a junction in electrical communication with (i) one of two ends of the first independent output for the first coils electrically connected in parallel, and (ii) one of two ends of the second independent output for the second coils electrically connected in series;
a first active buffer circuit having a first input and a first output, the first input in electrical communication with the junction;
a first parallel resistor-capacitor circuit in electrical communication with the first input;
a first variable resistor having first and second terminals of a resistive element and having a third terminal in variable electrical contact relative to the resistive element, the first terminal in electrical communication with the first output, the second terminal in electrical communication with a ground of the control circuitry, the third terminal in electrical communication with the first parallel resistor-capacitor circuit;
a second active buffer circuit having a second input and a second output, the second input in electrical communication with the other end of the first independent output;
a second parallel resistor-capacitor circuit in electrical communication with the second input; and
a second variable resistor having first and second terminals of a resistive element and having a third terminal in variable electrical contact relative to the resistive element, the first terminal in electrical communication with the second output, the second terminal in electrical communication with the ground, the third terminal in electrical communication with the second parallel resistor-capacitor circuit.

18. The electronic pickup assembly of claim 1, wherein each of the first and second rails share geometric and ferrous characteristics; and wherein each of the first, second, and intermediate permanent magnets share geometric and magnetic characteristics.

19. The electronic pickup assembly of claim 1, wherein the first rails have a first magnetic field strength that is approximately twice a second magnetic field strength of the second rails.

20. A stringed instrument, comprising an electronic pickup assembly according to claim 1.
